(19) United States
(12) Patent Application Publication
(10) Pub. No.: US 2023/0370146 A1
(43) Pub. Date: Nov. 16, 2023

(54) Active-Coordination-Set Beam Failure Recovery

(71) Applicant: Google LLC, Mountain View, CA (US)

(72) Inventors: Jibing Wang, San Jose, CA (US); Erik Richard Stauffer, Sunnyvale, CA (US)

(73) Assignee: Google LLC, Mountain View, CA (US)

(21) Appl. No.: 18/248,033

(22) PCT Filed: Sep. 29, 2021
(86) PCT No.: PCT/US2021/052672

§ 371 Date: Apr. 5, 2023

Related U.S. Application Data
(60) Provisional application No. 63/091,000, filed on Oct. 13, 2020.

(51) Int. Cl. H04B 7/06; H04B 7/024; H04B 7/08; H04W 76/19

(52) U.S. Cl. CPC H04B 7/0695; H04B 7/024; H04B 7/0888; H04W 76/19

(57) ABSTRACT

This document describes methods, devices, systems, and means for beam failure recovery for wireless communication in an active coordination set (ACS) by a user equipment (UE) in which the UE receives a beam-failure-recovery (BFR) Random Access Channel (RACH) configuration including multiple candidate beam configurations, each candidate beam configuration comprising a candidate BFR sub-beam configuration for each base station in the ACS. The UE detects a beam failure with the ACS and determines a respective link-quality metric for each of the received candidate beam configurations in the BFR RACH configuration. Based on the determined link-quality metrics, the UE selects a candidate beam to use for the wireless communication, and transmits a RACH message that includes an indication of the selected candidate beam, the transmitting being effective to direct the base stations in the ACS to use the selected candidate beam for the wireless communication.

### BACKGROUND

An Active Coordination Set (ACS) of base stations provides and optimizes mobility management and other services to a user equipment (UE) in a radio access network (RAN). The ACS may be a component of, or used to implement, a user-centric no-cell (UCNC) network architecture. As a UE moves through the coverage provided by the RAN, the UE continually determines and updates, from its perspective, which base stations are usable for wireless communication.

In high frequency bands, such as millimeter wave (mmWave) or terahertz (THz) frequency bands, user mobility may cause frequent beam failures due to changes in multipath propagation or signal blockage from buildings, foliage, or other obstructions. When employing techniques, such as Coordinated MultiPoint (CoMP), sub-beams from each base station in an ACS together form a beam for beamformed wireless connections with a UE. However, if one or more sub-beams fail due to rapidly changing radio-channel conditions, base stations in the ACS need coordinate to determine a set of sub-beams to form a new beam for satisfactory communication with the user equipment.

### SUMMARY

This summary is provided to introduce concepts of active-coordination-set beam failure recovery. The concepts are further described below in the Detailed Description. This summary is not intended to identify essential features of the claimed subject matter, nor is it intended for use in determining the scope of the claimed subject matter.

In aspects, methods, devices, systems, and means for beam failure recovery for wireless communication in an active coordination set (ACS) by a user equipment (UE) describe the user equipment receiving a beam-failure-recovery (BFR) Random Access Channel (RACH) configuration including multiple candidate beam configurations, each candidate beam configuration with a candidate BFR sub-beam configuration for each base station in the ACS. When the user equipment detects a beam failure during communication with the ACS and determines a respective link-quality metric for each of the received candidate beam configurations in the BFR RACH configuration. Based on the determined link-quality metrics, the user equipment selects a candidate beam to use for the wireless communication, and transmits a RACH message that includes an indication of the selected candidate beam, the transmitting being effective to direct the base stations in the ACS to use the selected candidate beam for the wireless communication.

In other aspects, methods, devices, systems, and means for beam failure recovery in an active coordination set describe a base station in the ACS that negotiates, with other base stations in the ACS, parameters for a BFR RACH configuration for a user equipment, the BFR RACH configuration including multiple candidate beam configurations, each candidate beam configuration with a respective candidate BFR sub-beam configuration for each base station in the ACS. The base station jointly-transmits, with the other base stations in the ACS, the BFR RACH configuration to the UE, the joint-transmission directing the UE to initialize parameters for a Beam Failure Detection and Recovery procedure. When the base station receives a RACH message from the UE that includes an indication of a selected candidate beam for the BFR, and based on the received RACH message, the base station coordinates with the other base stations to configure the base stations in the ACS to use the selected candidate beam for joint-communication with the UE. Along with the other base stations in the ACS, the base station jointly-transmits a RACH response message to the UE, with the RACH response message indicating that the ACS is using the selected candidate beam for the wireless communication with the UE. The base station jointly-communicates with the user equipment using the selected candidate beam indicated by the received RACH message, a superposition of the respective sub-beams of the base stations forming the selected candidate beam.

### BRIEF DESCRIPTION OF THE DRAWINGS

Aspects of active-coordination-set beam failure recovery are described with reference to the following drawings. The same numbers are used throughout the drawings to reference like features and components:

FIG. 1 illustrates an example wireless network system in which various aspects of active-coordination-set beam failure recovery can be implemented.

FIG. 2 illustrates an example device diagram that can implement various aspects of active-coordination-set beam failure recovery.

FIG. 3 illustrates an air interface resource that extends between a user equipment and a base station and with which various aspects of active-coordination-set beam failure recovery techniques can be implemented.

FIG. 4 illustrates an example of a user equipment moving through a radio access network that includes multiple base stations in accordance with aspects of active-coordination-set beam failure recovery techniques.

FIG. 5 illustrates an example environment in which various aspects of active-coordination-set beam failure recovery can be implemented.

FIG. 6 illustrates an example environment 600 in which a user equipment 110 is moving through a radio access network that includes multiple base stations in accordance with aspects of active-coordination-set beam failure recovery.

FIG. 7 illustrates example data and control transactions between an ACS and a UE in accordance with aspects of active-coordination-set beam failure recovery.

FIG. 8 illustrates an example method of active-coordination-set beam failure recovery as generally related to a user equipment selecting a candidate beam to recover from a beam failure in accordance with aspects of active-coordination-set beam failure recovery.

FIG. 9 illustrates an example method of active-coordination-set beam failure recovery as generally related to a base station configuring a beam failure recovery for a user equipment in accordance with aspects of active-coordination-set beam failure recovery.

### DETAILED DESCRIPTION

The evolution of wireless communication systems to fifth generation (5G) New Radio (5G NR) and Sixth Generation (6G) technologies provides higher data rates to users. By employing techniques, such as Coordinated MultiPoint (CoMP) over beamformed wireless connections, even higher data rates can be provided at the edges of 5G and 6G cells. However, identifying a satisfactory beam for communication between a user equipment (UE) and the base stations in an active coordination set (ACS) becomes increasingly complex at higher radio frequencies that are more susceptible to blockage and for UEs experiencing rapidly changing radio-channel conditions.

Conventional techniques for beam searches employ beam-sweeping during the attachment process of the UE with periodic beam-sweeping updates to identify a suitable beam for communication between a UE and a base station. These techniques are base-station-specific and do not fully account for the changing radio-channel environment of a user equipment communicating with multiple base stations in an ACS where a beam between the ACS and a UE is composed of sub-beams from each of the base stations in the ACS.

In aspects of active-coordination-set beam failure recovery, the base stations in an ACS coordinate with each other on a per-UE basis to determine configurations for beam-failure-recovery candidate beams. Collectively, the ACS determines a multi-base station beam-failure-recovery configuration, and the base stations coordinate to jointly-transmit a beam sweep for the candidate beams. During a beam-failure-recovery, each base station within the ACS transmits a specific sub-beam for each candidate beam, such that the superposition of sub-beams for each candidate beam from multiple base stations in the ACS forms the respective candidate beams within the candidate set of beams for the UE. Alternatively or additionally, the beam-failure-recovery process can be used to determine uplink receive beams for each base station in the ACS.

In conventional Coordinated Multipoint and/or Dual Connectivity (DC) communications, beam sweeps and beam failure recovery are independently performed by each base station or distributed unit in the CoMP or DC communication. In active-coordination-set beam failure recovery, the beam failure recovery is coordinated across the multiple base stations in the ACS. This coordination in beam failure recovery provides faster recovery of a usable beam configuration than independent beam recovery on a base station-by-base station basis to maintain higher bandwidth communications for the UE, especially in millimeter wave (mmWave) or terahertz (THz) frequency bands that are subject to frequent signal blocking and associated beam failures.

While features and concepts of the described devices, systems, and methods for active-coordination-set beam failure recovery can be implemented in any number of different environments, systems, devices, and/or various configurations, aspects of active-coordination-set beam failure recovery are described in the context of the following example devices, systems, and configurations.

### Example Environment

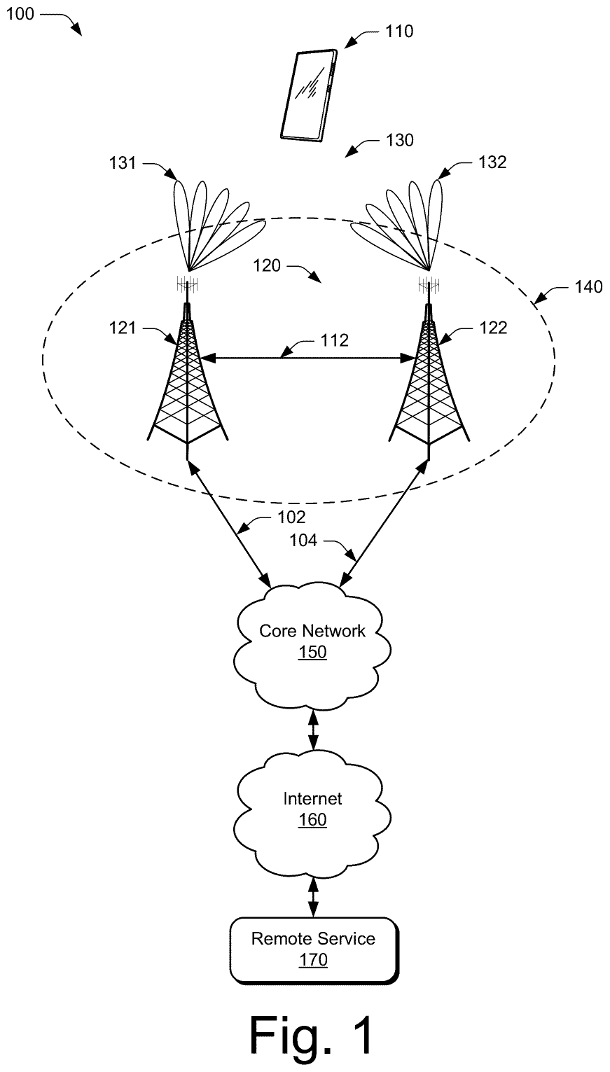

FIG. 1 illustrates an example environment 100 in which various aspects of active-coordination-set beam failure recovery can be implemented. The example environment 100 includes a user equipment 110 (UE 110) that communicates with one or more base stations 120 (illustrated as base stations 121 and 122), through one or more wireless communication links 130 (wireless link 130), illustrated as wireless links 131 and 132. In this example, the user equipment 110 is implemented as a smartphone. Although illustrated as a smartphone, the user equipment 110 may be implemented as any suitable computing or electronic device, such as a mobile communication device, a modem, cellular phone, gaming device, navigation device, media device, laptop computer, desktop computer, tablet computer, smart appliance, or vehicle-based communication system. The base stations 120 (e.g., an Evolved Universal Terrestrial Radio Access Network Node B, E-UTRAN Node B, evolved Node B, eNodeB, eNB, Next Generation Node B, gNode B, gNB, ng-eNB, a 6G node B, or the like) may be implemented in a macrocell, microcell, small cell, picocell, distributed base station, and the like, or any combination or future evolution thereof.

The base stations 120 communicate with the user equipment 110 via the wireless links 131 and 132, which may be implemented as any suitable type of wireless link. The wireless links 131 and 132 can include a downlink of data and control information communicated from the base stations 120 to the user equipment 110, an uplink of other data and control information communicated from the user equipment 110 to the base stations 120, or both. The wireless links 130 may include one or more wireless links or bearers implemented using any suitable communication protocol or standard, or combination of communication protocols or standards such as 3rd Generation Partnership Project Long-Term Evolution (3GPP LTE), Fifth Generation New Radio (5G NR), 6G, and so forth. Multiple wireless links 130 may be aggregated in a carrier aggregation to provide a higher data rate for the user equipment 110. Multiple wireless links 130 from multiple base stations 120 may be configured for Coordinated Multipoint (CoMP) communication with the user equipment 110. Additionally, multiple wireless links 130 may be configured for single-radio access technology (RAT) (single-RAT) dual connectivity (single-RAT-DC) or multi-RAT dual connectivity (MR-DC).

The base stations 120 are collectively a Radio Access Network 140 (RAN, Evolved Universal Terrestrial Radio Access Network, E-UTRAN, 5G NR RAN or NR RAN). The base stations 121 and 122 in the RAN 140 are connected to a core network 150, such as a Fifth Generation Core (5GC) or 6G core network. The base stations 121 and 122 connect, at 102 and 104 respectively, to the core network 150 via an NG2 interface (or a similar 6G interface) for control-plane signaling and via an NG3 interface (or a similar 6G interface) for user-plane data communications. In addition to connections to core networks, base stations 120 may communicate with each other via an Xn Application Protocol (XnAP), at 112, to exchange user-plane and control-plane data. The user equipment 110 may also connect, via the RAN 140 and the core network 150, to public networks, such as the Internet 160 to interact with a remote service 170.

### Example Devices

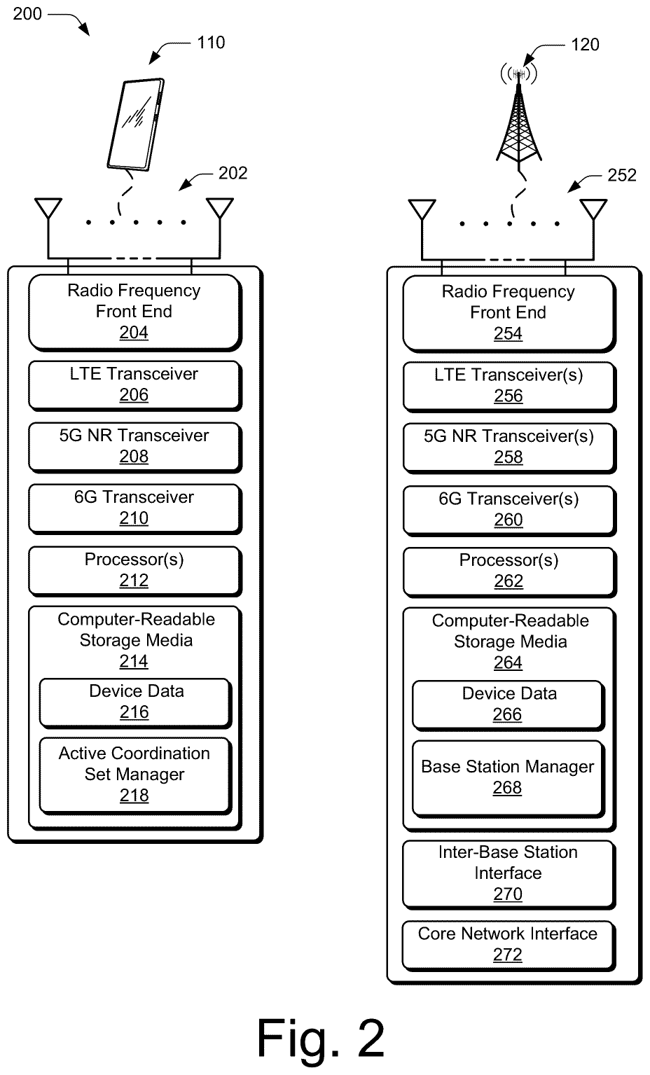

FIG. 2 illustrates an example device diagram 200 of the user equipment 110 and the base stations 120. The user equipment 110 and the base stations 120 may include additional functions and interfaces that are omitted from FIG. 2 for the sake of clarity. The user equipment 110 includes antennas 202, a radio frequency front end 204 (RF front end 204), an LTE transceiver 206, a 5G NR transceiver 208, and a 6G transceiver 210 for communicating with base stations 120 in the RAN 140. The RF front end 204 of the user equipment 110 can couple or connect the LTE transceiver 206, the 5G NR transceiver 208, and the 6G transceiver 210 to the antennas 202 to facilitate various types of wireless communication. The antennas 202 of the user equipment 110 may include an array of multiple antennas that are configured similarly to or differently from each other. The antennas 202 and the RF front end 204 can be tuned to, and/or be tunable to, one or more frequency bands defined by the 3GPP LTE, 5G NR, and 6G communication standards and implemented by the LTE transceiver 206, the 5G NR transceiver 208, and/or the 6G transceiver 210. Additionally, the antennas 202, the RF front end 204, the LTE transceiver 206, the 5G NR transceiver 208, and/or the 6G transceiver 210 may be configured to support beamforming for the transmission and reception of communications with the base stations 120. By way of example and not limitation, the antennas 202 and the RF front end 204 can be implemented for operation in sub-gigahertz bands, sub-6 GHz bands, and/or above 6 GHz bands that are defined by the 3GPP LTE, 5G NR, and 6G communication standards.

The user equipment 110 also includes processor(s) 212 and computer-readable storage media 214 (CRM 214). The processor 212 may be a single core processor or a multiple core processor composed of a variety of materials, such as silicon, polysilicon, high-K dielectric, copper, and so on. The computer-readable storage media described herein excludes propagating signals. CRM 214 may include any suitable memory or storage device such as random-access memory (RAM), static RAM (SRAM), dynamic RAM (DRAM), non-volatile RAM (NVRAM), read-only memory (ROM), or Flash memory useable to store device data 216 of the user equipment 110. The device data 216 includes user data, multimedia data, beamforming codebooks, applications, and/or an operating system of the user equipment 110, which are executable by processor(s) 212 to enable user-plane communication, control-plane signaling, and user interaction with the user equipment 110.

In some implementations, the CRM 214 may also include an active coordination set (ACS) manager 218. The ACS manager 218 can communicate with the antennas 202, the RF front end 204, the LTE transceiver 206, the 5G NR transceiver 208, and/or the 6G transceiver 210 to monitor the quality of the wireless communication links 130. Based on this monitoring, the ACS manager 218 can determine to add or remove base stations 120 from the ACS and/or determine beams to use for communication with base stations.

The device diagram for the base stations 120, shown in FIG. 2, includes a single network node (e.g., a gNode B). The functionality of the base stations 120 may be distributed across multiple network nodes or devices and may be distributed in any fashion suitable to perform the functions described herein. The base stations 120 include antennas 252, a radio frequency front end 254 (RF front end 254), one or more LTE transceivers 256, one or more 5G NR transceivers 258, and/or one or more 6G transceivers 260 for communicating with the UE 110. The RF front end 254 of the base stations 120 can couple or connect the LTE transceivers 256, the 5G NR transceivers 258, and/or the 6G transceivers 260 to the antennas 252 to facilitate various types of wireless communication. The antennas 252 of the base stations 120 may include an array of multiple antennas that are configured similarly to or differently from each other. The antennas 252 and the RF front end 254 can be tuned to, and/or be tunable to, one or more frequency band defined by the 3GPP LTE, 5G NR, and 6G communication standards, and implemented by the LTE transceivers 256, one or more 5G NR transceivers 258, and/or one or more 6G transceivers 260. Additionally, the antennas 252, the RF front end 254, the LTE transceivers 256, one or more 5G NR transceivers 258, and/or one or more 6G transceivers 260 may be configured to support beamforming, such as Massive-MIMO, for the transmission and reception of communications with the UE 110.

The base stations 120 also include processor(s) 262 and computer-readable storage media 264 (CRM 264). The processor 262 may be a single core processor or a multiple core processor composed of a variety of materials, such as silicon, polysilicon, high-K dielectric, copper, and so on. CRM 264 may include any suitable memory or storage device such as random-access memory (RAM), static RAM (SRAM), dynamic RAM (DRAM), non-volatile RAM (NVRAM), read-only memory (ROM), or Flash memory useable to store device data 266 of the base stations 120. The device data 266 includes network scheduling data, radio resource management data, beamforming codebooks, applications, and/or an operating system of the base stations 120, which are executable by processor(s) 262 to enable communication with the user equipment 110.

CRM 264 also includes a base station manager 268. Alternately or additionally, the base station manager 268 may be implemented in whole or part as hardware logic or circuitry integrated with or separate from other components of the base stations 120. In at least some aspects, the base station manager 268 configures the LTE transceivers 256, the 5G NR transceivers 258, and the 6G transceiver(s) 260 for communication with the user equipment 110, as well as communication with a core network, such as the core network 150, and routing user-plane and control-plane data for joint communication. Additionally, the base station manager 268 may allocate air interface resources, schedule communications, configure beam recovery configurations, and preform beam-sweeps for the UE 110 and base stations 120 in the ACS when the base station 120 is acting as a coordinating base station for the base stations 120 in the ACS.

The base stations 120 include an inter-base station interface 270, such as an Xn and/or X2 interface, which the base station manager 268 configures to exchange user-plane and control-plane data between other base stations 120, to manage the communication of the base stations 120 with the user equipment 110. The base stations 120 include a core network interface 272 that the base station manager 268 configures to exchange user-plane and control-plane data with core network functions and/or entities.

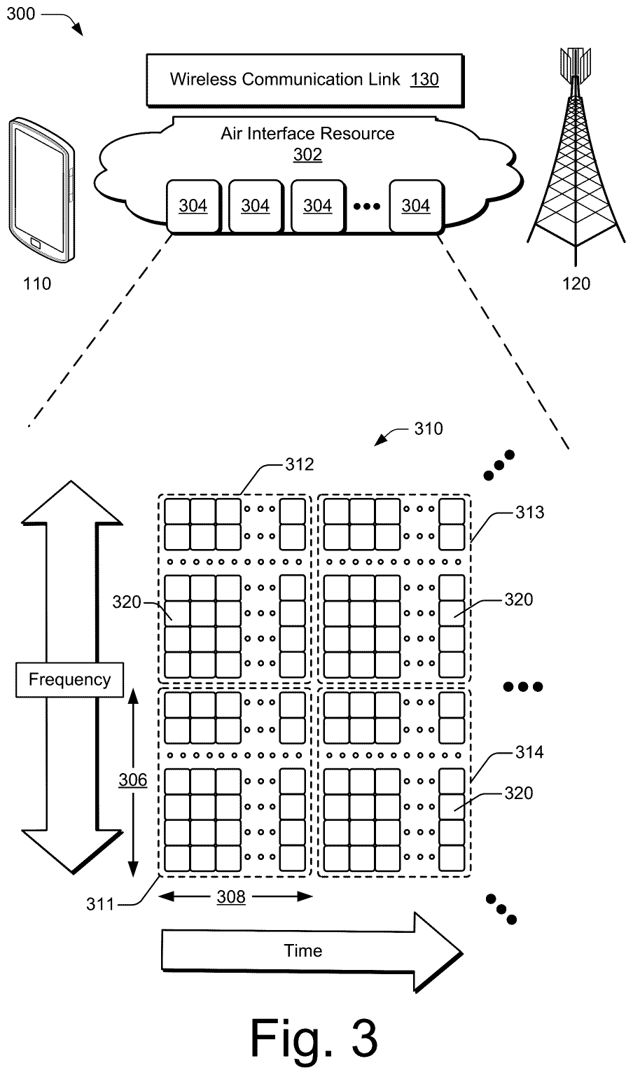

FIG. 3 illustrates an air interface resource that extends between a user equipment and a base station and with which various aspects of active-coordination-set beam failure recovery can be implemented. The air interface resource 302 can be divided into resource units 304, each of which occupies some intersection of frequency spectrum and elapsed time. A portion of the air interface resource 302 is illustrated graphically in a grid or matrix having multiple resource blocks 310, including example resource blocks 311, 312, 313, 314. An example of a resource unit 304 therefore includes at least one resource block 310. As shown, time is depicted along the horizontal dimension as the abscissa axis, and frequency is depicted along the vertical dimension as the ordinate axis. The air interface resource 302, as defined by a given communication protocol or standard, may span any suitable specified frequency range, and/or may be divided into intervals of any specified duration. Increments of time can correspond to, for example, milliseconds (mSec). Increments of frequency can correspond to, for example, megahertz (MHz).

In example operations generally, the base stations 120 allocate portions (e.g., resource units 304) of the air interface resource 302 for uplink and downlink communications. Each resource block 310 of network access resources may be allocated to support respective wireless communication links 130 of multiple user equipment 110. In the lower left corner of the grid, the resource block 311 may span, as defined by a given communication protocol, a specified frequency range 306 and comprise multiple subcarriers or frequency sub-bands. The resource block 311 may include any suitable number of subcarriers (e.g., 12) that each correspond to a respective portion (e.g., 15 kHz) of the specified frequency range 306 (e.g., 180 kHz). The resource block 311 may also span, as defined by the given communication protocol, a specified time interval 308 or time slot (e.g., lasting approximately one-half millisecond or seven orthogonal frequency-division multiplexing (OFDM) symbols). The time interval 308 includes subintervals that may each correspond to a symbol, such as an OFDM symbol. As shown in FIG. 3, each resource block 310 may include multiple resource elements 320 (REs) that correspond to, or are defined by, a subcarrier of the frequency range 306 and a subinterval (or symbol) of the time interval 308. Alternatively, a given resource element 320 may span more than one frequency subcarrier or symbol. Thus, a resource unit 304 may include at least one resource block 310, at least one resource element 320, and so forth.

In example implementations, multiple user equipment 110 (one of which is shown) are communicating with the base stations 120 (one of which is shown) through access provided by portions of the air interface resource 302. The base station manager 268 (shown in FIG. 2) may determine a respective data-rate, type of information, or amount of information (e.g., data or control information) to be communicated (e.g., transmitted) by the user equipment 110. For example, the base station manager 268 can determine that each user equipment 110 is to transmit at a different respective data rate or transmit a different respective amount of information. The base station manager 268 then allocates one or more resource blocks 310 to each user equipment 110 based on the determined data rate or amount of information.

Additionally, or in the alternative to block-level resource grants, the base station manager 268 may allocate resource units at an element-level. Thus, the base station manager 268 may allocate one or more resource elements 320 or individual subcarriers to different user equipment 110. By so doing, one resource block 310 can be allocated to facilitate network access for multiple user equipment 110. Accordingly, the base station manager 268 may allocate, at various granularities, one or up to all subcarriers or resource elements 320 of a resource block 310 to one user equipment 110 or divided across multiple user equipment 110, thereby enabling higher network utilization or increased spectrum efficiency.

The base station manager 268 can therefore allocate air interface resource 302 by resource unit 304, resource block 310, frequency carrier, time interval, resource element 320, frequency subcarrier, time subinterval, symbol, spreading code, some combination thereof, and so forth. Based on respective allocations of resource units 304, the base station manager 268 can transmit respective messages to the multiple user equipment 110 indicating the respective allocation of resource units 304 to each user equipment 110. Each message may enable a respective user equipment 110 to queue the information or configure the LTE transceiver 206, the 5G NR transceiver 208, and/or the 6G transceiver 210 to communicate via the allocated resource units 304 of the air interface resource 302.

### Active Coordination Set

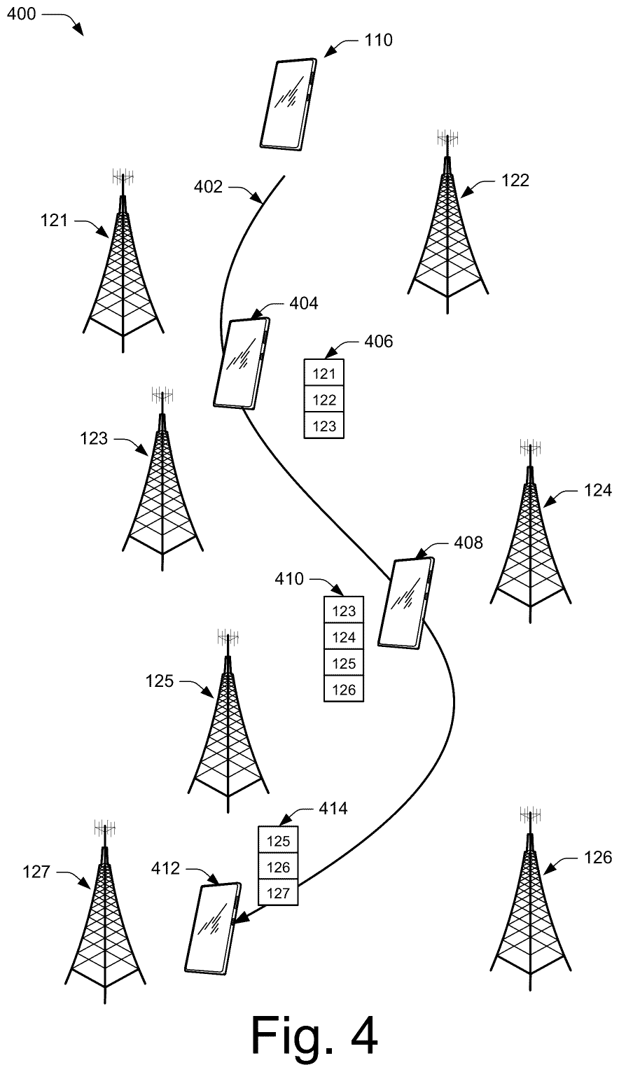

FIG. 4 illustrates an example environment 400 in which a user equipment 110 is moving through a radio access network (RAN) that includes multiple base stations 120, illustrated as base stations 121-127. These base stations may utilize different technologies (e.g., LTE, 5G NR, 6G) at a variety of frequencies (e.g., sub-gigahertz, sub-6 GHz, and above 6 GHz bands and sub-bands).

For example, the user equipment 110 follows a path 402 through the RAN 140. The user equipment 110 periodically measures the link quality (e.g., of base stations that are currently in the ACS and candidate base stations that the UE 110 may add to the ACS. For example, at position 404, the ACS at 406 includes the base stations 121, 122, and 123. As the UE 110 continues to move, at position 408, the UE 110 has deleted base station 121 and base station 122 from the ACS and added base stations 124, 125, and 126, as shown at 410. Continuing along the path 402, the UE 110, at position 412, has deleted the base stations 123 and 124 and added the base station 127, as shown in the ACS at 414.

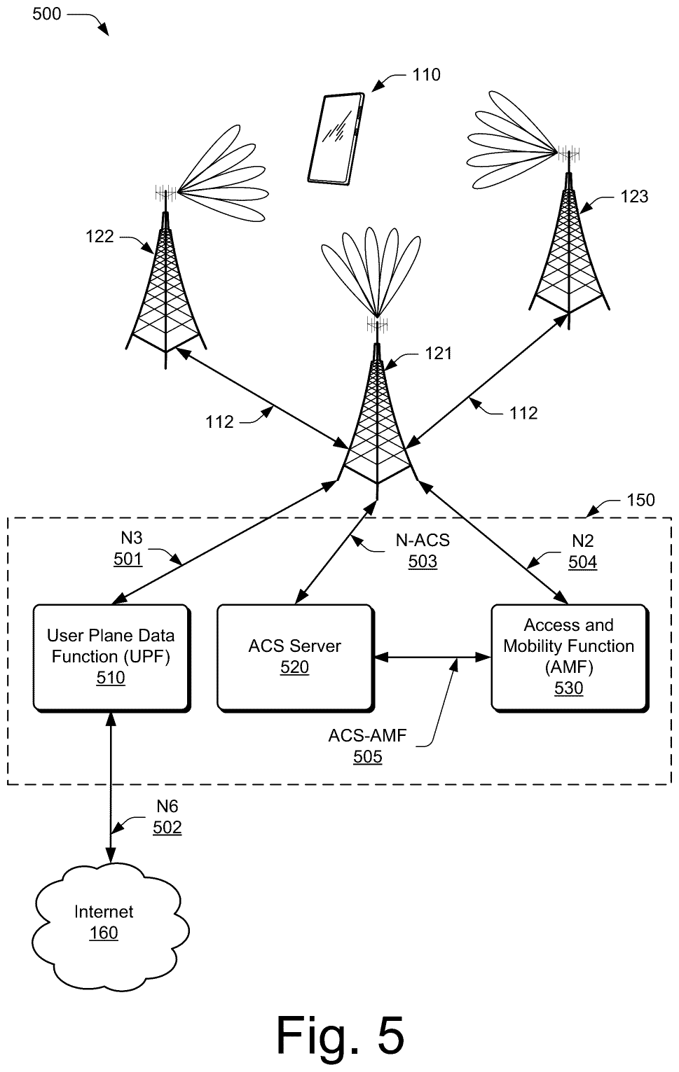

FIG. 5 illustrates an example environment 500 in which various aspects of active-coordination-set beam failure recovery can be implemented. The user equipment 110 is engaged in joint transmission and/or joint reception (joint communication) with the three base stations 121, 122, and 123. The base station 121 is acting as a coordinating base station for the joint transmission and/or joint reception. Which base station is the coordinating base station is transparent to the UE 110, and the coordinating base station can change as base stations are added and/or removed from the ACS. The coordinating base station coordinates control-plane and user-plane communications for the joint communication with the UE 110 via the Xn interfaces 112 (or a similar 6G interface) to the base stations 122 and 123 and maintains the user-plane context between the UE 110 and the core network 150. The coordination may be performed using proprietary or standards-based messaging, procedures, and/or protocols.

The coordinating base station schedules air interface resources for the joint communication for the UE 110 and the base stations 121, 122, and 123, based on the ACS associated with the UE 110. The coordinating base station (base station 121) connects, via an N3 interface 501 (or a 6G equivalent interface), to the User Plane Function 510 (UPF 510) in the core network 150 for the communication of user plane data to and from the user equipment 110. The coordinating base station distributes the user-plane data to all the base stations in the joint communication via the Xn interfaces 112. The UPF 510 is further connected to a data network, such as the Internet 160 via the N6 interface 502.

UE 110 downlink data can be sent from all the base stations 120 in the ACS or any subset of the base stations 120 in the ACS. The coordinating base station 121 determines which combination of base stations 120 in the ACS to use to transmit downlink data to the UE 110. The selection of base stations 120 to use to transmit downlink data can be based on one or more factors, such as application quality of service (QoS) requirements, location of the UE 110, velocity of the UE 110, a Reference Signal Received Power (RSRP), a Received Signal Strength Indicator (RSSI), interference, or the like. UE 110 uplink data can be received by all the base stations 120 in the ACS or any subset of the base stations 120 in the ACS.

Similar to downlink data, the coordinating base station 121 determines which combination of base stations 120 in the ACS to use to receive uplink data from the UE 110. The selection of base stations 120 to use to receive uplink data can be based on one or more factors, such as application QoS requirements, location of the UE 110, velocity of the UE 110, RSRP, RSSI, interference, or the like. Typically, the combination of base stations 120 for downlink transmission and uplink reception will be identical, although different combinations of base stations 120 may be used for downlink transmission and uplink reception. The ACS uplink and downlink assignments may also vary depending on the demand for available air interface resources at the individual base stations for other UEs, IAB, and other purposes.

When the user equipment 110 creates or modifies an ACS, the user equipment 110 communicates the ACS or the ACS modification to an ACS Server 520 that stores the ACS for each user equipment 110 operating in the RAN 140. Although shown in the core network 150, alternatively the ACS Server 520 may be an application server located outside the core network 150. The user equipment 110 communicates the ACS or ACS modification via the coordinating base station (base station 121) which is connected to the ACS Server 520 via an N-ACS interface 503. Optionally or alternatively, the user equipment 110 communicates the ACS or ACS modification to the ACS Server 520 via the Access and Mobility Function 530 (AMF 530) which is connected to the coordinating base station (base station 121) via an N2 interface 504. The AMF 530 relays ACS-related communications to and from the ACS Server 520 via an ACS-AMF interface 505. ACS data between the user equipment 110 and the ACS Server 520 can be communicated via Radio Resource Control (RRC) communications, Non-Access Stratum (NAS) communications, or application-layer communications.

### Active-Coordination-Set Beam Failure Recovery

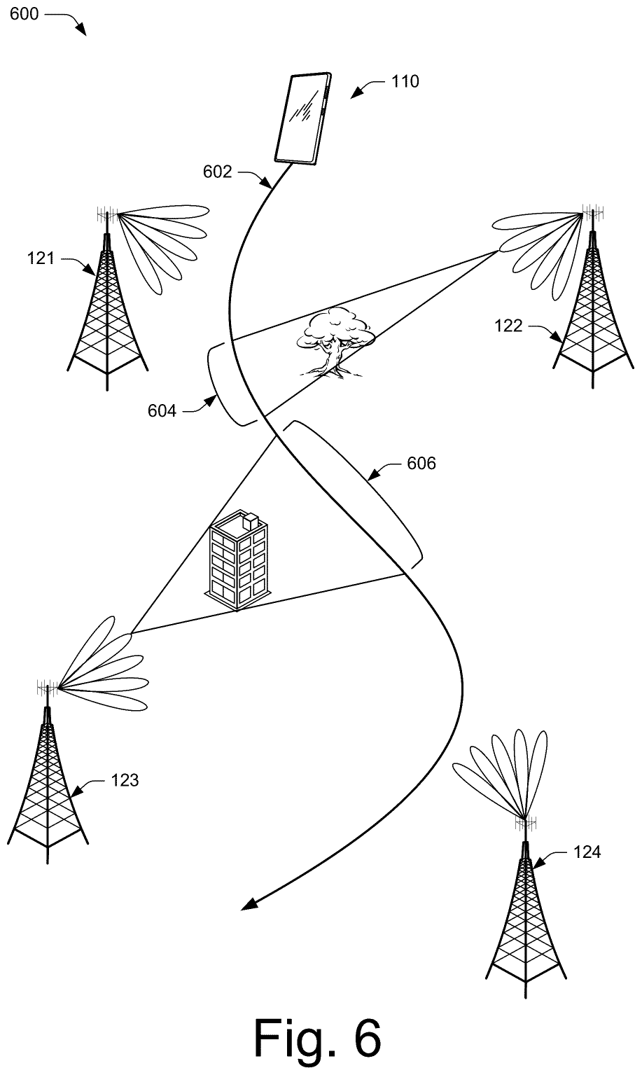

FIG. 6 illustrates an example environment 600 in which a user equipment 110 is moving through a radio access network (RAN) that includes multiple base stations 120, illustrated as base stations 121-124. These base stations may support different technologies (e.g., LTE, 5G NR, 6G) at a variety of frequencies (e.g., sub-gigahertz, sub-6 GHz, above 6 GHz bands and sub-bands, mmWave bands, and THz bands).

For example, the user equipment 110 follows a path 602 through the RAN 140 while communicating using an ACS including base stations 121, 122, 123, and 124. Each of the base stations 121, 122, 123, and 124 provides a sub-beam for a beamformed joint communication between the UE 110 and the ACS. As the UE 110 passes through the region 604 of the path 602, a sub-beam (e.g., a sub-beam in the mmWave or THz bands) provided by the base station 122 is blocked by foliage reducing the link quality of the beam collectively provided by the ACS. Based on the sub-beam blockage causing a beam failure, the UE initiates a Beam Failure Detection and Recovery procedure (as described below) to determine a new beam configuration for joint-communication with the ACS.

As the UE 110 continues along the path 602, the UE 110 experiences a second beam failure in the region 606 due to blockage of the sub-beam from the base station 123 by a building. As before, based on this second beam failure, the UE initiates another Beam Failure Detection and Recovery procedure to determine another new beam configuration for joint-communication with the ACS.

Base stations in an ACS coordinate with each other on a per-UE basis to determine configurations for beam-failure-recovery candidate beams. Collectively, the ACS determines a multi-base station beam-failure-recovery configuration. For each candidate beam, each base station within ACS transmits a specific sub-beam, such that the superposition of sub-beams from multiple base stations in the ACS forms one of the candidate beams within the candidate set of beams for the UE.

Each base station within an ACS can determine an individual sub-beam for a candidate beam in a beam-failure-recovery configuration based on UE-specific information. For example, the base station may determine candidate sub-beams based on the location of the UE, the velocity of the UE, the heading of the UE, a projected course of the UE (e.g., along an established walkway or roadway), UE-reported Reference Signal Receive Powers (RSRPs), or the like. The ACS beam-failure-recovery configuration includes a UE-specific ACS-Radio Network Temporary Identifier (ACS-RNTI), the candidate beam-failure-recovery (BFR) sub-beam configuration for each base station in the ACS, time/frequency air interface resources for the candidate beams, a BFR sequence (BFR RACH preamble sequence) common to all candidate beams, and the like for each BFR beam.

The ACS sends a beam-failure-recovery (BFR) Random Access Channel (RACH) configuration to each UE communicating using that ACS. For each UE, the coordinating base station for the ACS negotiates with the other base stations in the ACS to determine the BFR RACH configuration for the Beam Failure Detection and Recovery procedure. The ACS beam-failure-recovery RACH configuration includes the RACH time/frequency air interface resources as well as RACH sequences to use for the BFR.

Each base station within an ACS uses its own beam correspondence to determine the receive beam for an uplink (UL) RACH associated with the UE beam failure recovery. Base stations within the ACS coordinate to determine a power ramping step (e.g., powerRampingStep in 3GPP TS 38.321 V16.1.0) for the beam-failure-recovery RACH. The ACS includes the power ramping step as the powerRampingStep parameter in the RACH configuration for the beam failure recovery. In one example, the ACS determines the power ramping step based on a joint-processing signal-to-interference-plus-noise ratio (SINR) of UE uplink signals as observed by the ACS.

Base stations within the ACS negotiate the timing of the beam-failure response with respect to the received beam-failure request. The timing depends on the timing of the joint-reception and joint-processing of the received RACH message for the beam-failure request by the ACS. For example, the timing of the joint-reception and joint-processing depends on Xn interface latency between the base stations in the ACS.

The ACS can define an ACS Channel State Information (CSI) process such that a single ACS CSI feedback represents the superposition of sub-beams from each base station in the ACS. The ACS defines the ACS CSI process for each UE by including the ACS CSI time/frequency air interface resource configurations for each sub-beam used by each base station in the ACS. Each base station uses feedback from the UE for each ACS CSI process to determine the sub-beam(s) used in a beam-failure-recovery candidate beam.

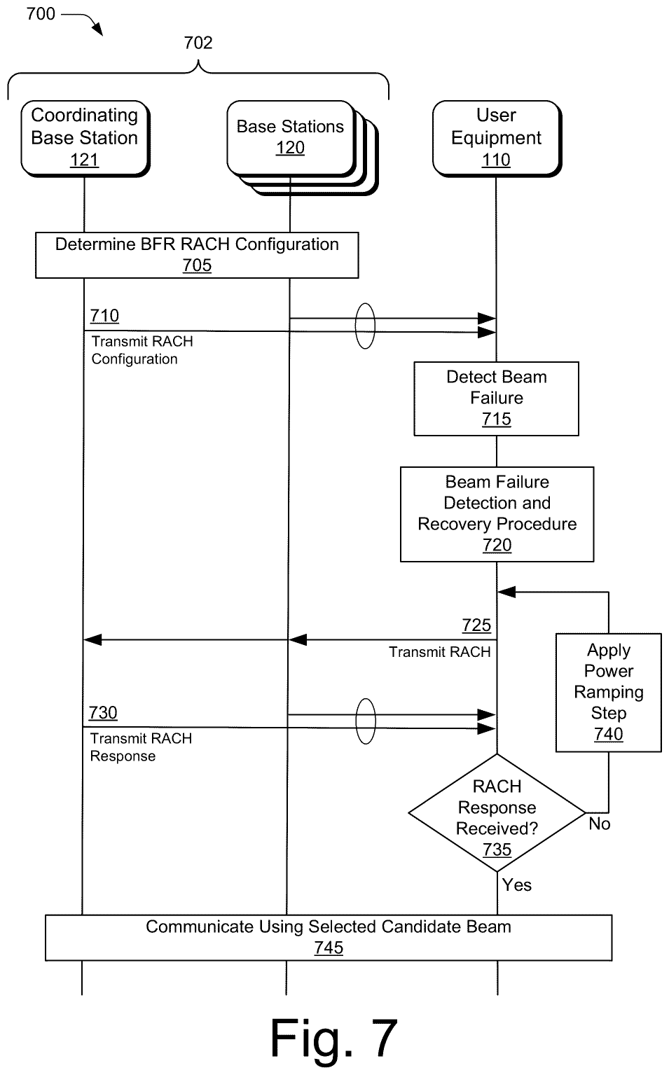

FIG. 7 illustrates example data and control transactions between an ACS and a UE in accordance with aspects of active-coordination-set beam failure recovery. An ACS 702, including the coordinating base station 121 and one or more additional base stations 120, is jointly-communicating (joint transmission and/or joint reception) with the UE 110.

At 705, the ACS 702 determines a beam-failure-recovery (BFR) RACH configuration for initialization of a Beam Failure Detection and Recovery procedure (e.g., a Random Access procedure) by the UE 110. The ACS can include the beam-failure-recovery RACH configuration in a configuration for initialization of a Random Access procedure (e.g., as described in 3GPP TS 38.321 V16.1.0, section 5.1.1). The beam-failure-recovery RACH configuration includes a UE-specific ACS-Radio Network Temporary Identifier (ACS-RNTI), the candidate beam-failure-recovery (BFR) sub-beam configuration for each base station in the ACS, time/frequency air interface resources for the candidate beams, a BFR sequence (BFR RACH preamble sequence), and the like for each BFR beam. This BFR RACH configuration determination can be triggered periodically or based on past history of ACS beam failures (e.g., by the same UE or by other UEs, with the same ACS or coordinating base station). For example, trigger conditions include a UE-reported RSRP, a UE-reported Reference Signal Received Quality (RSRQ), a UE-reported downlink SINR, a base station observed uplink SINR, a base station received signal level on a UE Sounding Reference Signal (SRS), or the like.

At 710, the base stations in the ACS 702 jointly-transmit the beam-failure-recovery RACH configuration to the UE 110. The ACS 702 can transmit the BFR RACH configuration in a layer-3 message, for example a Radio Resource Control (RRC) message.

At some point in time after receiving the beam-failure-recovery RACH configuration, the UE 110 detects a beam failure at 715. At 720, the detection of the beam failure causes the UE 110 to trigger the Beam Failure Detection and Recovery procedure to search for a beam configuration for communication with the ACS 702. For example, the UE 110 determines a link-quality metric, for example an ACS CSI feedback value, for each of the candidate beams in the BFR RACH configuration and selects the candidate beam with the best link-quality metric (ACS CSI feedback value). Optionally or additionally, the UE 110 can select the first candidate beam that exceeds a threshold value for the link-quality metric, thus reducing the time to select a candidate beam configuration as compared to evaluating all the candidate beams before selecting a candidate beam.

At 725, based on selecting the candidate beam configuration for communication with the ACS 702, the UE 110 transmits a RACH message that includes an indication of the selected candidate beam to the ACS 702. In one option, the UE 110 transmits the RACH message in a sub-6 GHz frequency band to improve the likelihood of reception by the ACS. At 730, the ACS 702 transmits a RACH response message to the UE 110 indicating the ACS is using the selected candidate beam for communication with the UE 110. Additionally, at 725, the UE 110 initializes a timer for the reception of the RACH response message. At 735, if the timer expires before the UE receives the RACH response message, the UE retransmits the RACH message. To account for communication latencies over the Xn interface between the base station in the ACS, the timer value may be longer than a timer value used for beam-failure-recovery with a single base station. Optionally, if the ACS 702 configures a power ramping step to direct increases of the transmit power for retransmissions of the RACH message, the UE at 740 increases the transmit power for the RACH message by the specified power ramping step and retransmits the RACH message.

At 745, the base stations in the ACS 702 begin joint-communication with the UE 110 using the selected candidate beam configuration. Each base station 120 communicates using its respective sub-beam to form the selected beam.

### Example Methods

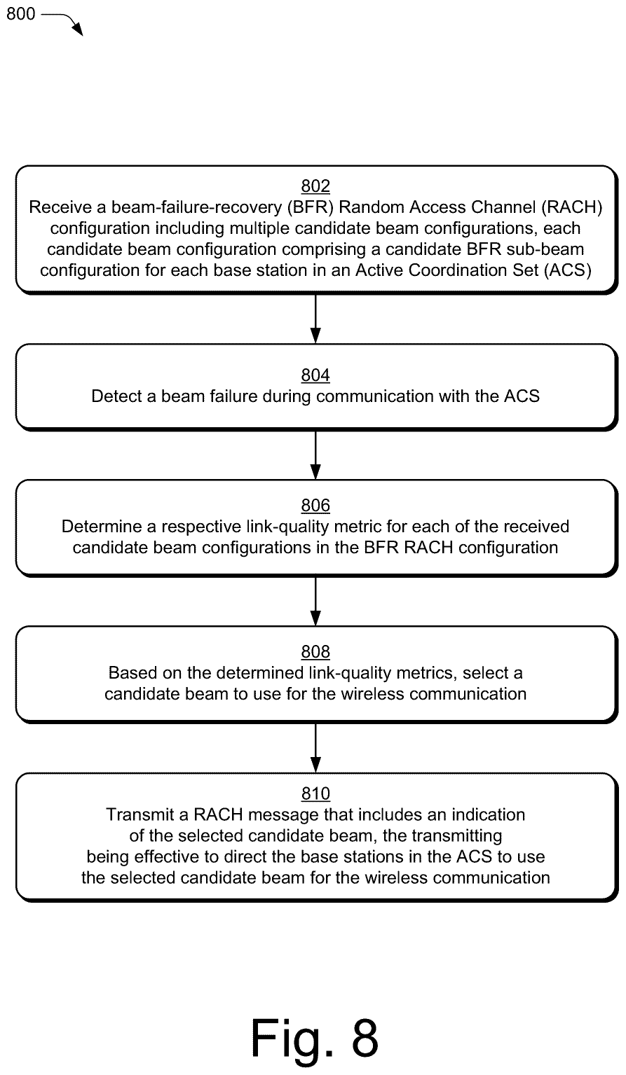

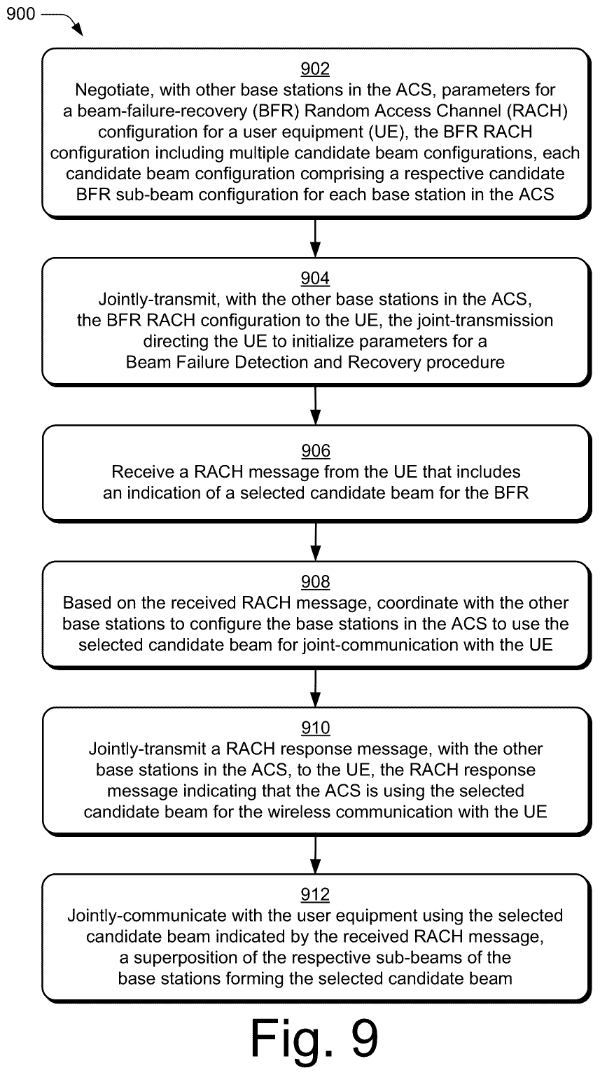

Example methods 800 and 900 are described with reference to FIGS. 8 and 9 in accordance with one or more aspects of active-coordination-set beam failure recovery. FIG. 8 illustrates example method(s) 800 of active-coordination-set beam failure recovery as generally related to the user equipment 110 selecting a candidate beam to recover from a beam failure.

At block 802, a user equipment receives a beam-failure-recovery (BFR) Random Access Channel (RACH) configuration including multiple candidate beam configurations, each candidate beam configuration comprising a candidate BFR sub-beam configuration for each base station in the ACS. For example, a UE (e.g., the UE 110) receives a BFR RACH configuration including multiple candidate beam configurations, each candidate beam configuration comprising a candidate BFR sub-beam configuration for each base station (e.g., the base stations 120) in the ACS (e.g., the ACS 702).

At block 804, the user equipment detects a beam failure during communication with the ACS. For example, the user equipment 110 detects a beam failure during communication with the ACS 702 that causes the UE 110 to trigger the Beam Failure Detection and Recovery procedure to search for a new beam configuration for communication with the ACS 702.

At block 806, the user equipment determines a respective link-quality metric for each of the received candidate beam configurations in the BFR RACH configuration. For example, the user equipment 110 determines a respective link-quality metric, for example a Reference Signal Receive Power (RSRP), for each of the received candidate beam configurations in the BFR RACH configuration.

At block 808, based on the determined link-quality metrics, the user equipment selects a candidate beam to use for the wireless communication. For example, based on the determined link-quality metrics, the user equipment 110 selects a candidate beam (e.g., the candidate beam with highest RSRP) to use for the wireless communication.

At block 810, the user equipment transmits a RACH message that includes an indication of the selected candidate beam, the transmitting being effective to direct the base stations in the ACS to use the selected candidate beam for the wireless communication. For example, the user equipment 110 transmits a RACH message, including an indication of the selected candidate beam, that directs each base station 120 and 121 in the ACS to use a respective sub-beam configuration for the selected candidate beam for the wireless communication.

FIG. 9 illustrates example method(s) 900 of active-coordination-set beam failure recovery as generally related to a base station configuring a beam failure recovery (BFR) for a user equipment. At block 902, a base station negotiates, with other base stations in the ACS, parameters for a BFR Random Access Channel (RACH) configuration for a user equipment, the BFR RACH configuration including multiple candidate beam configurations, each candidate beam configuration comprising a respective candidate BFR sub-beam configuration for each base station in the ACS. For example, a base station (e.g., a coordinating base station 121) negotiates, with other base stations (e.g., the base stations 120) in the ACS (e.g., the ACS 702), parameters for a BFR RACH configuration for a user equipment (e.g., the UE 110). The BFR RACH configuration includes multiple candidate beam configurations, each candidate beam configuration comprising a respective candidate BFR sub-beam configuration for each base station 120 and 121 in the ACS 702. For example, base stations may conduct the negotiation using an inter-base station interface (e.g., the Xn interface 112) for communication between the base stations in the ACS 702.

At block 904, the base station jointly-transmits, with the other base stations in the ACS, the BFR RACH configuration to the UE, the joint-transmission directing the UE to initialize parameters for a Beam Failure Detection and Recovery procedure. For example, the coordinating base station 121 jointly-transmits, with the other base stations 120 in the ACS 702, the BFR RACH configuration to the UE 110, the jointly-transmitting directing the UE 110 to initialize parameters for a Beam Failure Detection and Recovery procedure that can be triggered by the UE 110 upon the detection of a beam failure. The BFR RACH configuration includes a power ramping step parameter, an indication of air interface resources for the candidate beams, a BFR sequence, or the like.

At block 906, the base station receives a RACH message from the UE that includes an indication of a selected candidate beam for the BFR. For example, the coordinating base station 121 receives a RACH message from the UE 110 that includes an indication of a candidate beam selected by the UE 110 for the BFR.

At block 908, based on the received RACH message, the base station coordinates with the other base stations to configure the base stations in the ACS to use the selected candidate beam for joint-communication with the UE. For example, based on the received RACH message, the coordinating base station 121 coordinates with the other base stations 120 to configure the base stations in the ACS 702 to provide sub-beams for the selected candidate beam for joint-communication with the UE 110.

At block 910, the base station jointly-transmits a RACH response message, with the other base stations in the ACS, to the UE, the RACH response message indicating that the ACS is using the selected candidate beam for the wireless communication with the UE. For example, the coordinating base station 121 jointly-transmits a RACH response message, with the other base stations 120 in the ACS 702, to the UE 110, the RACH response message indicating that the ACS 702 is using the selected candidate beam for the wireless communication with the UE 110. The base stations coordinate the timing of the joint transmission using the Xn interface.

At block 912, the base station jointly-communicates with the user equipment using the selected candidate beam indicated by the received RACH message, a superposition of the respective sub-beams of the base stations forming the selected candidate beam. For example, the coordinating base station 121 and the other base stations 120 in the ACS 702 jointly-communicate with the user equipment 110 using the selected candidate beam indicated by the received RACH message, a superposition of the respective sub-beams of the base stations forming the selected candidate beam.

The order in which the method blocks are described are not intended to be construed as a limitation, and any number of the described method blocks can be skipped or combined in any order to implement a method or an alternate method. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

In the following text some examples are described:
Example 1: A method of beam failure recovery for wireless communication in an active coordination set, ACS, comprising multiple base stations, by a user equipment, UE, the method comprising the user equipment:
   receiving a beam-failure-recovery, BFR, Random Access Channel, RACH, configuration including multiple candidate beam configurations, each candidate beam configuration comprising a candidate BFR sub-beam configuration for each of the multiple base stations in the ACS;
   detecting a beam failure during communication with the ACS;
   determining a respective link-quality metric for each of the received candidate beam configurations in the BFR RACH configuration;
   based on the determined link-quality metrics, selecting a candidate beam to use for the wireless communication based on the multiple candidate beam configurations; and
   transmitting a RACH message that includes an indication of the selected candidate beam, the transmitting being effective to direct the base stations in the ACS to use the selected candidate beam for the wireless communication.
Example 2: The method of example 1, further comprising the user equipment:
   receiving a RACH response message from the ACS that indicates that the ACS is using the selected candidate beam for the wireless communication.
Example 3: The method of example 2, further comprising the user equipment:
   initializing a timer concurrently with the transmitting the RACH message; and
   if the timer expires before the receiving the RACH response message, retransmitting the RACH message.
Example 4: The method of example 3, wherein the BFR RACH configuration includes a power ramping step parameter, the method further comprising the user equipment:
   increasing a transmit power for the retransmitting the RACH message by an amount of power indicated by the power ramping step parameter.
Example 5: The method of any one of the preceding examples, wherein the selected candidate beam for the wireless communication is a superposition of multiple candidate sub-beams, each candidate sub-beam transmitted or received by a respective base station of the multiple base stations in the ACS.
Example 6: The method of any one of the preceding examples, wherein the receiving the BFR RACH configuration comprises:
   receiving the BFR RACH configuration in a layer-3 message.
Example 7: The method of example 6, wherein the layer-3 message is a Radio Resource Control, RRC, message.
Example 8: The method of any one of the preceding examples, wherein a configuration for initialization of a Random Access procedure includes the BFR RACH configuration.
Example 9: The method of any one of the preceding examples, wherein the BFR RACH configuration includes an indication of air interface resources for the candidate beams and a BFR sequence.
Example 10: The method of any one of the preceding examples, wherein the determining the respective link-quality metric for each of the received candidate beam configurations in the BFR RACH configuration comprises:
   receiving an ACS Channel State Information, CSI, time/frequency resource configuration for each candidate beam; and
   determining ACS CSI feedback for each of the received candidate beams.
Example 11: The method of any one of the preceding examples, wherein the selecting the candidate beam to use for the wireless communication based on the multiple candidate beam configurations comprises:
   selecting a first candidate beam with a link-quality metric that exceeds a threshold value.
Example 12: The method of any one of the preceding examples, wherein transmitting the RACH message that includes the indication of the selected candidate beam comprises:
   transmitting the RACH message using a sub-6 GHz frequency band.
Example 13: The method of any one of the preceding examples, further comprising the user equipment:
   jointly-communicating with the ACS using the selected candidate beam indicated by the transmitted RACH message, the selected candidate beam being formed by superposition of a respective sub-beam of each of the multiple base stations in the ACS.
Example 14: A user equipment comprising:
   a wireless transceiver;
   a processor; and
   instructions for an active coordination set manager that are executable by the processor to configure the user equipment to perform any one of methods 1 to 13.
Example 15: A method of beam failure recovery, BFR, in an active coordination set, ACS, the method comprising a base station in the ACS:
   negotiating, with other base stations included in the ACS, parameters for a BFR Random Access Channel, RACH, configuration for a user equipment, UE, the BFR RACH configuration including multiple candidate beam configurations, each candidate beam configuration comprising a respective candidate BFR sub-beam configuration for each base station in the ACS;
   jointly-transmitting, with the other base stations included in the ACS, the BFR RACH configuration to the UE;
   receiving a RACH message from the UE that includes an indication of a selected candidate beam for the BFR based on the multiple candidate beam configurations; and
   based on the received RACH message, coordinating with the other base stations to configure the base stations in the ACS to use the selected candidate beam for joint-communication with the UE.
Example 16: The method of example 15, wherein the parameters for the BFR RACH configuration include one or more of:
   a power ramping step parameter;
   an indication of air interface resources for the candidate beams; or
   a BFR sequence.
Example 17: The method of example 15 or example 16, wherein the jointly-transmitting the BFR RACH configuration to the UE comprises:
   jointly-transmitting the BFR RACH configuration in a layer-3 message.
Example 18: The method of example 17, wherein the layer-3 message is a Radio Resource Control, RRC, message.
Example 19: The method of any one of examples 11 to 18, further comprising the base station:
   including the BFR RACH configuration in a configuration for initialization of a Random Access procedure.
Example 20: The method of any one of examples 15 to 19, wherein the negotiating the parameters for the BFR RACH configuration comprises:
   determining candidate sub-beams based on one or more of:
   a location of the UE;
   a velocity of the UE;
   a heading of the UE;
   a projected course of the UE; or
   one or more UE-reported Reference Signal Receive Powers, RSRPs.
Example 21: The method of any one of examples 15 to 20, wherein the negotiating the parameters for the BFR RACH configuration comprises:
   determining a power ramping step for a Beam Failure Detection and Recovery procedure; and
   including the determined power ramping step in the BFR RACH configuration.
Example 22: The method of example 21, wherein the determining a power ramping step for the BFR comprises:
   determining the power ramping step based on a joint-processing signal-to-interference-plus-noise ratio (SINR) of the UE as observed by the ACS.
Example 23: The method of any one of examples 15 to 22, wherein the negotiating the parameters for the BFR RACH configuration comprises:
   negotiating with the other base stations using an Xn interface for communication with the other base stations in the active coordination set.
Example 24: The method of any one of examples 15 to 23, further comprising the base station:
   jointly-communicating with the user equipment using the selected candidate beam indicated by the received RACH message, the selected candidate beam being formed by superposition of a respective sub-beam of each of the base stations in the ACS.
Example 25: The method of any one of examples 15 to 23, the method further comprising the base station:
   jointly-transmitting a RACH response message, with the other base stations in the ACS, to the UE, the RACH response message indicating that the ACS is using the selected candidate beam for wireless communication with the UE.
Example 26: A base station comprising:
   a wireless transceiver;
   a processor; and
   instructions for a base station manager that are executable by the processor to configure the base station to perform any one of methods 15 to 25.
Example 27: A computer-readable medium comprising instructions that, when executed by a processor, cause an apparatus comprising the processor to perform any of the methods of examples 1 to 13 or 15 to 25.

Although aspects of active-coordination-set beam failure recovery have been described in language specific to features and/or methods, the subject of the appended claims is not necessarily limited to the specific features or methods described. Rather, the specific features and methods are disclosed as example implementations of active-coordination-set beam failure recovery, and other equivalent features and methods are intended to be within the scope of the appended claims. Further, various different aspects are described, and it is to be appreciated that each described aspect can be implemented independently or in connection with one or more other described aspects.

1. A method of beam failure recovery for wireless communication in an active coordination set (ACS) comprising multiple base stations, by a user equipment (UE) the method comprising the UE:
receiving a beam-failure-recovery (BFR) Random Access Channel (RACH) configuration including multiple candidate beam configurations, each candidate beam configuration comprising a candidate BFR sub-beam configuration for each of the multiple base stations in the ACS;
detecting a beam failure during communication with the ACS;
determining a respective link-quality metric for each candidate BFR sub-beam configurations;
based on the determined link-quality metrics, selecting a candidate beam based on the multiple candidate BFR sub-beam configurations; and
transmitting a RACH message that includes an indication of the selected candidate beam, the transmitting being effective to direct the base stations in the ACS to use the selected candidate beam for the wireless communication.

2. The method of claim 1, further comprising the user equipment:
receiving a RACH response message from the ACS that indicates that the ACS is using the selected candidate beam for the wireless communication.

3. The method of claim 1, wherein the selected candidate beam for the wireless communication is a superposition of multiple candidate sub-beams, each candidate sub-beam transmitted or received by a respective base station of the multiple base stations in the ACS.

4. The method of claim 1, wherein the receiving the BFR RACH configuration comprises:
receiving the BFR RACH configuration in a Radio Resource Control (RRC) message.

5. The method of claim 1, wherein a configuration for initialization of a Random Access procedure includes the BFR RACH configuration.

6. The method of claim 1, wherein the BFR RACH configuration includes an indication of air interface resources for the candidate beams and a BFR sequence.

7. The method of claim 1, wherein the determining the respective link-quality metric for each of the received candidate BFR sub-beam configurations in the BFR RACH configuration comprises:
receiving an ACS Channel State Information (CSI) time/frequency resource configuration for each candidate beam; and
determining ACS CSI feedback for each of the received candidate beams.

8. The method of claim 1, wherein the selecting the candidate beam based on the multiple candidate BFR sub-beam configurations comprises:
selecting a first candidate beam with a link-quality metric that exceeds a threshold value.

9. The method of claim 1, further comprising the user equipment:
jointly-communicating with the ACS using the selected candidate beam indicated by the transmitted RACH message, the selected candidate beam being formed by superposition of a respective sub-beam of each of the multiple base stations in the ACS.

10. A user equipment (UE) comprising:
a wireless transceiver;
a processor; and
instructions for an active coordination set manager that are executable by the processor to configure the UE to:
receive a beam-failure-recovery (BFR) Random Access Channel (RACH), configuration including multiple candidate beam configurations, each candidate beam configuration comprising a candidate BFR sub-beam configuration for each of multiple base stations in an active coordination set (ACS);
detect a beam failure during communication with the ACS
determine a respective link-quality metric for each candidate BFR sub-beam configurations;
based on the determined link-quality metrics, select a candidate beam based on the multiple candidate BFR sub-beam configurations; and
transmit a RACH message that includes an indication of the selected candidate beam, the transmitting being effective to direct the base stations in the ACS to use the selected candidate beam for the wireless communication.

11. A method of beam failure recovery (BFR) in an active coordination set (ACS) the method comprising a base station in the ACS:
negotiating, with other base stations included in the ACS, parameters for a BFR Random Access Channel (RACH) configuration for a user equipment (UE) the BFR RACH configuration including multiple candidate beam configurations, each candidate beam configuration comprising a respective candidate BFR sub-beam configuration for each base station in the ACS;
jointly-transmitting, with the other base stations included in the ACS, the BFR RACH configuration to the UE;
receiving a RACH message from the UE that includes an indication of a selected candidate beam for the BFR from the multiple candidate beam configurations; and
based on the received RACH message, coordinating with the other base stations to configure the base stations in the ACS to use the selected candidate beam for joint-communication with the UE.

12. The method of claim 11, wherein the parameters for the BFR RACH configuration include one or more of:
a power ramping step parameter;
an indication of air interface resources for the candidate beams; or
a BFR sequence.

13. The method of claim 11, wherein the jointly-transmitting the BFR RACH configuration to the UE comprises:
jointly-transmitting the BFR RACH configuration in a Radio Resource Control (RRC) message.

14. The method of claim 11, wherein the negotiating the parameters for the BFR RACH configuration comprises:
determining candidate sub-beams based on one or more of:
a location of the UE;
a velocity of the UE;
a heading of the UE;
a projected course of the UE; or
one or more UE-reported Reference Signal Receive Powers (RSRPs).

15. The method of claim 11, wherein the negotiating the parameters for the BFR RACH configuration comprises:
determining a power ramping step for a Beam Failure Detection and Recovery procedure; and
including the determined power ramping step in the BFR RACH configuration.

16. The method of claim 15, wherein the determining a power ramping step for the BFR comprises:
determining the power ramping step based on a joint-processing signal-to-interference-plus-noise ratio (SINR) of the UE as observed by the ACS.

17. The method of claim 11, wherein the negotiating the parameters for the BFR RACH configuration comprises:
negotiating with the other base stations using an Xn interface for communication with the other base stations in the active coordination set.

18. The method of claim 11, further comprising the base station:
jointly-communicating with the user equipment using the selected candidate beam indicated by the received RACH message, the selected candidate beam being formed by superposition of a respective sub-beam of each of the base stations in the ACS.

19. A base station comprising:
a wireless transceiver;
a processor; and
instructions for a base station manager that are executable by the processor to configure the base station to:
negotiate, with other base stations included in an active coordination set (ACS), parameters for a beam failure recovery (BFR) Random Access Channel (RACH) configuration for a user equipment (UE) the BFR RACH configuration including multiple candidate beam configurations, each candidate beam configuration comprising a respective candidate BFR sub-beam configuration for each base station in the ACS;
jointly-transmit, with the other base stations included in the ACS, the BFR RACH configuration to the UE;
receive a RACH message from the UE that includes an indication of a selected candidate beam for the BFR from the multiple candidate beam configurations; and
based on the received RACH message, coordinate with the other base stations to configure the base stations in the ACS to use the selected candidate beam for joint-communication with the UE.

20. (canceled)

21. The base station of claim 19, the base station manager further executable by the processor to configure the base station to:
jointly-communicate with the UE using the selected candidate beam indicated by the received RACH message, the selected candidate beam being formed by superposition of a respective sub-beam of each of the base stations in the ACS.
